(19) United States
(12) Patent Application Publication
(10) Pub. No.: US 2024/0126988 A1
(43) Pub. Date: Apr. 18, 2024

(54) WORD EXTRACTION DEVICE, WORD EXTRACTION SYSTEM AND WORD EXTRACTION METHOD

(71) Applicant: Hitachi, Ltd., Tokyo (JP)

(72) Inventors: Ekant Muljibhai AMIN, Tokyo (JP); Takeshi HOMMA, Tokyo (JP)

(21) Appl. No.: 18/470,194

(22) Filed: Sep. 19, 2023

(30) Foreign Application Priority Data
Oct. 6, 2022 (JP) 2022-161372

(51) Int. Cl. G06F 40/205; G06F 40/237

(52) U.S. Cl. CPC G06F 40/205; G06F 40/237

(57) ABSTRACT

Aspects relate to improving accuracy of word extraction. A word extraction device includes a lexical representation generation unit for acquiring training data including sentences in which target extraction words are specified, generating a first lexical representation by processing the training data with a first parsing technique, generating a second lexical representation by processing the training data with a second parsing technique, and generating a first combined lexical representation by combining the first lexical representation and the second lexical representation; a query representation generation unit for generating, based on the first combined lexical representation, an extraction query representation indicating a query for extracting the target extraction words from a predetermined target search document; and a word extraction unit for extracting, by using the extraction query representation, extraction information that indicates information about the target extraction words from a second combined lexical representation generated based on the target search document.

### CROSS-REFERENCE TO RELATED APPLICATIONS

The present application claims priority to Japanese Patent Application No. 2022-161372, filed Oct. 6, 2022. The contents of this application are incorporated herein by reference in their entirety.

### BACKGROUND OF THE INVENTION

The invention relates to a word extraction device, word extraction system and word extraction method.

### SUMMARY OF THE INVENTION

In recent years, with the development of computers and the Internet, the amount of electronic information has increased significantly, and much of this electronic information consists of natural language that humans use for everyday communication. In this context, natural language processing is known as a means of analyzing natural language and deriving meaningful insights.

In current natural language processing research, Lexical Knowledge Extraction (LKE) techniques, which extract specific words or sentences (hereinafter referred to as “target extraction words”) from documents consisting of natural language text information, have attracted much attention. In LKE techniques, the target extraction words are extracted from the target search documents according to extraction rules generated by a parsing technique.

For example, US Patent Application Publication No. 2010/0082331 (Patent Document 1) exists as one means for generating rules for extracting words.

Patent Document 1 describes a technique in which “A system and method of developing rules for text processing enable retrieval of instances of named entities in a predetermined semantic relation (such as the DATE and PLACE of an EVENT) by extracting patterns from text strings in which attested examples of named entities satisfying the semantic relation occur. The patterns are generalized to form rules which can be added to the existing rules of a syntactic parser and subsequently applied to text to find candidate instances of other named entities in the predetermined semantic relation.”

In principle, documents consisting of textual information in natural language contain syntactic information about the syntactic relationships of words and semantic information about the semantic relationships of words. When extracting words from a given target search document, it is desirable to consider both the syntactic and semantic information of the words.

However, according to conventional LKE techniques, although the rules for extracting words can extract one of either the syntactic information or the semantic information of the words, there is no technique for creating extraction rules that consider both the syntactic information and the semantic information words.

For example, the above-mentioned Patent Document 1 describes a means of generating rules for extracting words by analyzing patterns of predetermined relationships existing in training data, such as text strings, using a so-called syntactic parsing technique.

However, in the technique described in Patent Document 1, as the rules for extracting words are generated only by syntactic parsing techniques, although it is possible to create rules for extracting the syntactic information associated with words, the semantic information associated with the words cannot be extracted. On the other hand, semantic parsing techniques exist that can extract the semantic information associated with words, but such semantic parsing techniques cannot extract the syntactic information about words.

As a result, conventional LKE techniques that use only one parsing technique, such as Patent Document 1, for example, cannot generate extraction rules that consider both the syntactic parsing information and the semantic information in the target search documents, which limits the accuracy of word extraction.

Accordingly, it is an object of the present disclosure to provide a word extraction technique that can improve the accuracy of word extraction by combining parsing techniques, such as syntactic parsing techniques and semantic parsing techniques, and leveraging the features of these multiple parsing techniques.

To solve the above problems, one representative word extraction device according to the present invention includes a processor; and a memory, wherein the memory includes processing instructions for causing the processor to function as: a lexical representation generation unit for acquiring training data that includes sentences in which target extraction words are specified, generating a first lexical representation by processing the training data with a first parsing technique, generating a second lexical representation by processing the training data with a second parsing technique, and generating a first combined lexical representation by combining the first lexical representation and the second lexical representation; a query representation generation unit for generating, based on the first combined lexical representation, an extraction query representation that indicates a query for extracting the target extraction words from a predetermined target search document; and a word extraction unit for extracting, by using the extraction query representation, extraction information that indicates information about the target extraction words from a second combined lexical representation generated based on the target search document.

According to the present disclosure, it is possible to provide a word extraction technique that can improve the accuracy of word extraction by combining parsing techniques, such as syntactic parsing techniques and semantic parsing techniques, and leveraging the features of these multiple parsing techniques.

Problems, configurations, and effects other than those described above will be made clear by the following description in the embodiments for carrying out the invention.

### BRIEF DESCRIPTION OF THE DRAWINGS

FIG. 1 is a diagram illustrating a computer system for implementing the embodiments of the present disclosure.

FIG. 2 is a diagram for explaining an overview of a manual extraction rule generation technique in LKE.

FIG. 3 is a diagram for explaining an overview of an automatic extraction rule generation technique in LKE.

FIG. 4 is a diagram illustrating an example configuration of a word extraction system according to the embodiments of the present disclosure.

FIG. 5 is a diagram illustrating a functional configuration of a word extraction device according to the embodiments of the present disclosure.

FIG. 6 is a diagram illustrating a functional configuration in which a DP technique and an AMR technique are used as parsing techniques in the word extraction device according to the embodiments of the present disclosure.

FIG. 7 is a diagram illustrating an example of the flow of a combination process according to the embodiments of the present disclosure.

FIG. 8 is a diagram illustrating an example of generating a combined lexical representation by combining a first lexical representation and a second lexical representation according to the embodiments of the present disclosure.

FIG. 9 is a diagram illustrating an example of generating an extraction query representation according to the embodiments of the present disclosure.

FIG. 10 is a diagram illustrating an example of a case where AND/OR matching is used as a graph search technique according to the embodiments of the present disclosure.

FIG. 11 is a diagram illustrating an example of a case where matching based on performance criteria of the parsing techniques is used as a graph search technique according to the embodiments of the present disclosure.

FIG. 12 is a diagram illustrating an example of a case where a matching necessity criterion is used as a graph search technique according to the embodiments of the present disclosure.

FIG. 13 is a diagram illustrating an example of a case where lexical attribute information is used as a graph search technique according to the embodiments of the present disclosure.

FIG. 14 is a diagram illustrating an example of a case where related terms are used as a graph search technique according to the embodiments of the present disclosure.

### DETAILED DESCRIPTION

Hereinafter, the embodiments of the present invention will be described with reference to the drawings. It should be noted that the invention is not limited by these embodiments. In addition, in the description of the drawings, identical parts will be indicated with the same reference numerals.

It should also be understood that although terms such as “first,” “second,” “third,” and the like may be used to describe various elements or components in the present disclosure, the elements or components are not limited by these terms. These terms are used only to distinguish one element or component from other elements of components. Accordingly, a first element or component discussed below may also be referred to as a second element or component without departing from the teachings of the present invention.

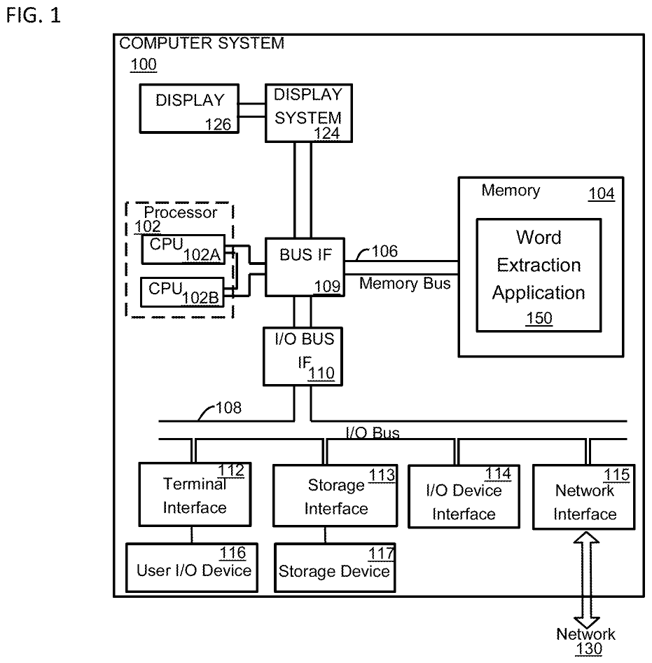

Referring first to FIG. 1, a computer system 100 for implementing the embodiments of the present disclosure will be described. The mechanisms and devices of the various embodiments disclosed herein may be applied to any suitable computing system. The main components of the computer system 100 include one or more processors 102, a memory 104, a terminal interface 112, a storage interface 113, an I/O (Input/Output) device interface 114, and a network interface 115. These components may be interconnected via a memory bus 106, an I/O bus 108, a bus interface unit 109, and an I/O bus interface unit 110.

The computer system 100 may include one or more general purpose programmable central processing units (CPUs), 102A and 102B, herein collectively referred to as the processor 102. In some embodiments, the computer system 100 may contain multiple processors, and in other embodiments, the computer system 100 may be a single CPU system. Each processor 102 executes instructions stored in the memory 104 and may include an on-board cache.

In some embodiments, the memory 104 may include a random access semiconductor memory, storage device, or storage medium (either volatile or non-volatile) for storing data and programs. The memory 104 may store all or a part of the programs, modules, and data structures that perform the functions described herein. For example, the memory 104 may store a word extraction application 150. In some embodiments, the word extraction application 150 may include instructions or statements that execute the functions described below on the processor 102.

In some embodiments, the word extraction application 150 may be implemented in hardware via semiconductor devices, chips, logic gates, circuits, circuit cards, and/or other physical hardware devices in lieu of, or in addition to processor-based systems. In some embodiments, the word extraction application 150 may include data other than instructions or statements. In some embodiments, a camera, sensor, or other data input device (not shown) may be provided to communicate directly with the bus interface unit 109, the processor 102, or other hardware of the computer system 100.

The computer system 100 may include a bus interface unit 109 for communicating between the processor 102, the memory 104, a display system 124, and the I/O bus interface unit 110. The I/O bus interface unit 110 may be coupled with the I/O bus 108 for transferring data to and from the various I/O units. The I/O bus interface unit 110 may communicate with a plurality of I/O interface units 112, 113, 114, and 115, also known as I/O processors (IOPs) or I/O adapters (IOAs), via the I/O bus 108.

The display system 124 may include a display controller, a display memory, or both. The display controller may provide video, audio, or both types of data to the display device 126. Further, the computer system 100 may also include a device, such as one or more sensors, configured to collect data and provide the data to the processor 102.

For example, the computer system 100 may include biometric sensors that collect heart rate data, stress level data, and the like, environmental sensors that collect humidity data, temperature data, pressure data, and the like, and motion sensors that collect acceleration data, movement data, and the like. Other types of sensors may be used. The display system 124 may be connected to a display device 126, such as a single display screen, television, tablet, or portable device.

The I/O interface unit is capable of communicating with a variety of storage and I/O devices. For example, the terminal interface unit 112 supports the attachment of a user I/O device 116, which may include user output devices such as a video display device, a speaker, a television or the like, and user input devices such as a keyboard, mouse, keypad, touchpad, trackball, buttons, light pens, or other pointing devices or the like. A user may use the user interface to operate the user input device to input input data and instructions to the user I/O device 116 and the computer system 100 and receive output data from the computer system 100. The user interface may be presented via the user I/O device 116, such as displayed on a display device, played via a speaker, or printed via a printer.

The storage interface 113 supports the attachment of one or more disk drives or direct access storage devices 117 (which are typically magnetic disk drive storage devices, but may be arrays of disk drives or other storage devices configured to appear as a single disk drive). In some embodiments, the storage device 117 may be implemented as any secondary storage device. The contents of the memory 104 are stored in the storage device 117 and may be read from the storage device 117 as needed. The I/O device interface 114 may provide an interface to other I/O devices such as printers, fax machines, and the like. The network interface 115 may provide a communication path so that computer system 100 and other devices can communicate with each other. The communication path may be, for example, the network 130.

In some embodiments, the computer system 100 may be a multi-user mainframe computer system, a single user system, or a server computer or the like that has no direct user interface and receives requests from other computer systems (clients). In other embodiments, the computer system 100 may be a desktop computer, a portable computer, a notebook computer, a tablet computer, a pocket computer, a telephone, a smart phone, or any other suitable electronic device.

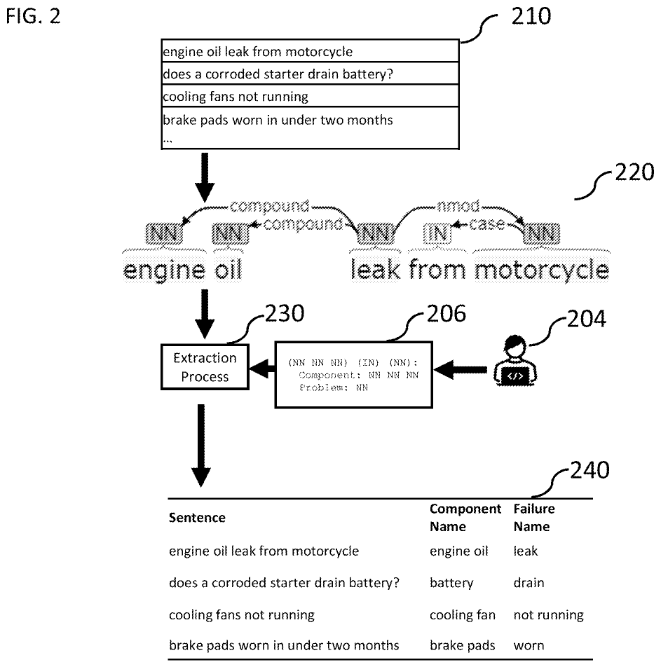

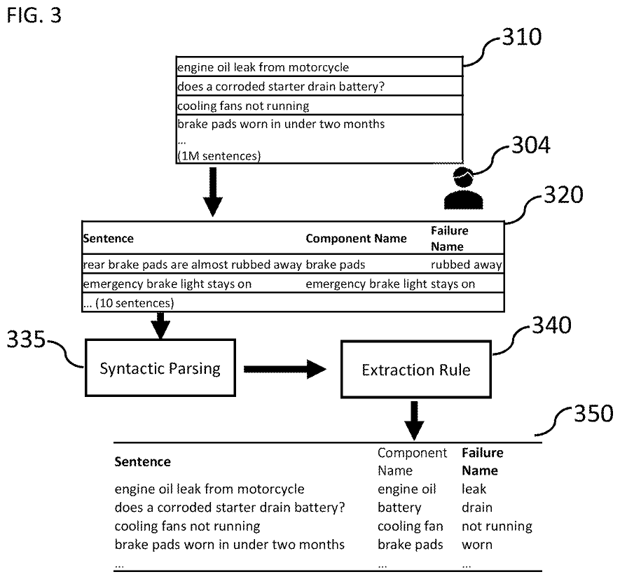

As mentioned above, Lexical Knowledge Extraction (LKE) generally includes manual techniques in which extraction rules for extracting words are manually generated, and automatic techniques in which extraction rules are generated using parsing techniques. FIGS. 2-3 below provide an overview of these manual and automatic extraction rule generation techniques.

FIG. 2 is a diagram for explaining an overview of a manual extraction rule generation technique 200 in LKE.

In the manual extraction rule generation technique 200, a user 204, such as a developer, creates in advance extraction rules 206 for extracting target extraction words from a given target search document 210. The extraction rules 206 here may be rules generated using syntactic parsing techniques such as Dependency Tree (DT) or Part of Speech (PoS), for example.

Next, in the extraction process 230, the extraction information 240 including the target extraction words is extracted from the syntactic representation 220 of the target search document 210 based on the extraction rules 206.

As an example, if the extraction rule 206 created by the user is a rule for extracting, from documents related to component failures (e.g., the target search document 210), the component name of the failing component, failure name, and a sentence containing the component name and the failure name, then, from the sentence “engine oil leak from motorcycle,” “engine oil” may be extracted as the component name and “leak” may be extracted as the failure name, and this information may be used as the extraction information 240.

FIG. 3 is a diagram for explaining an overview of an automatic extraction rule generation technique 300 in LKE.

In the automatic extraction rule generation technique 300, a user 304, such as a developer, generates labeled training data 320 by assigning labels (flags) to the target sentences 310 that identify the target extraction words. As an example, the user 304 may assign a label that identifies the component name of a failing component and a failure name of the failure in a document related to component failures.

Next, the parsing technique 335 (e.g., a syntactic parsing technique or a semantic parsing technique) automatically generates extraction rules 340 for extracting the target extraction words based on the training data 320 generated by the user 304. The generated extraction rules 340 can then be applied to the target search document (a syntactic representation of the target search document) to extract extraction information 350 from the target search document that includes the target extraction words.

As mentioned above, the manual extraction rule generation technique 200 and the automatic extraction rule generation technique 300 can extract target extraction words from a given target search document.

However, as described above, conventional LKE techniques that use only one parsing technique, such as Patent Document 1, for example, cannot generate extraction rules that take into account both the syntactic parsing information and the semantic information in the target search document, which limits the accuracy of word extraction.

Accordingly, the present disclosure relates to a word extraction technique that can improve the accuracy of word extraction by combining parsing techniques, such as syntactic parsing techniques and semantic parsing techniques, and leveraging the features of these multiple parsing techniques.

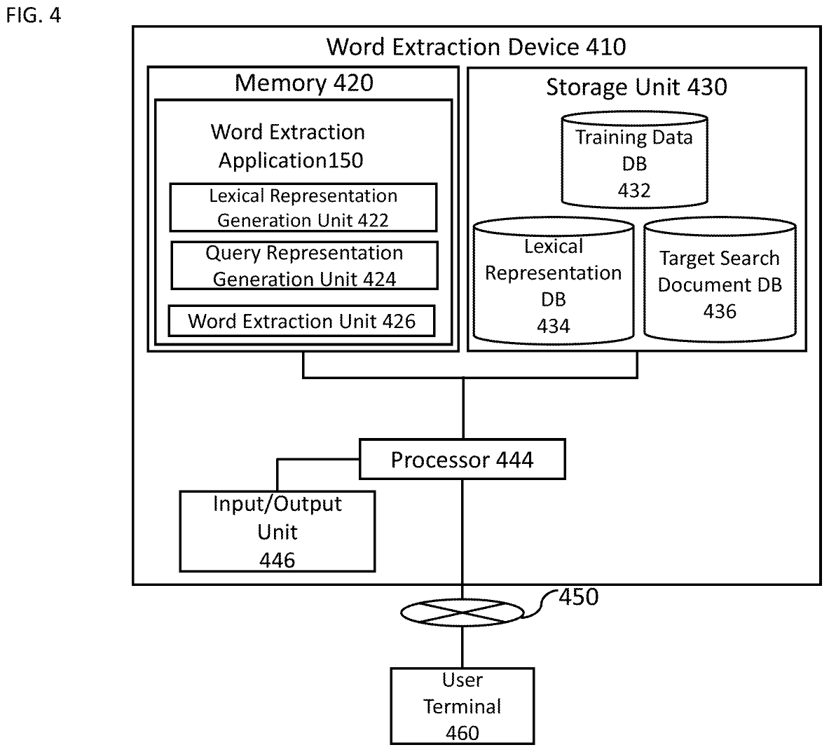

Next, FIG. 4 describes a word extraction system according to the embodiments of the present disclosure.

FIG. 4 is a diagram illustrating an example configuration of a word extraction system 400 according to the embodiments of the present disclosure. The word extraction system 400 is a system for extracting extraction information including target extraction words from a given target search document and providing it to users. As illustrated in FIG. 4, the word extraction system 400 comprises a word extraction device 410, a communication network 450, and a user terminal 460. In the word extraction system 400, the word extraction device 410 and the user terminal 460 may be connected to each other via the communication network 450.

The word extraction device 410 is a device for extracting extraction information including target extraction words from a given search target document using extraction rules generated by multiple parsing techniques, such as syntactic parsing techniques and semantic parsing techniques, for example, and, as illustrated in FIG. 4, primarily includes a memory 420, a storage unit 430, a processor 444 and an input/output unit 446.

In embodiments, the word extraction device 410 may be implemented by the computer system 100 illustrated in FIG. 1.

The memory 420 may be a memory for storing a word extraction application 150 for implementing the functions of the word extraction technique according to the embodiments of the present disclosure. The word extraction application 150 may include processing instructions for implementing the functions of software modules such as a lexical representation generation unit 422, a query representation generation unit 424, and word extraction unit 426, as illustrated in FIG. 4.

The lexical representation generation unit 422 is a functional unit for using multiple parsing techniques to process training data including sentences in which target extraction words are specified, thereby generating multiple lexical representations corresponding to the training data, and generating a combined lexical representation (a first combined lexical representation) by combining these multiple lexical representations. A lexical representation as used herein may include a data structure that defines the words in the sentences included in the training data and the relationship between these words. This lexical representation may be a table, a matrix, a graph, or the like, for example. In the present disclosure, a case in which the lexical representation is in a graph format will be used as an example.

In addition, the parsing techniques used to generate the lexical representation are not limited, but may include, for example, syntactic parsing techniques such as Dependency Parsing (DP) techniques and semantic parsing techniques such as Abstract Meaning Representation (AMR) techniques.

The query representation generation unit 424 is a functional unit for generating an extraction query representation that indicates a query for extracting target extraction words from a given target search document based on the combined lexical representation generated by the lexical representation generation unit 422. This extraction query representation is a data structure that defines rules for extracting the target extraction words, and may be in a graphical format similar to the lexical representation. In embodiments, this extraction query representation may be a sub-graph that represents a portion of the first combined lexical representation (e.g., a sub-graph containing the words or relationships to be extracted).

The word extraction unit 426 is a functional unit for extracting extraction information indicating information about target extraction words from a given target search document by using the extraction query representation generated by the query representation generation unit 424. The details of the graph search technique used by the word extraction unit 426 are described below, so a description thereof is omitted here.

The storage unit 430 is a storage area that houses a database (“DB”) for storing various information pertaining to the embodiments of this disclosure, and may include a training data DB 432, a lexical representation DB 434, and a target search document DB 436, as illustrated in FIG. 4.

The training data DB 432 is a database for storing training data including sentences in which target extraction words are specified. In embodiments, the training data DB 432 may store training data input by the user via the user terminal 460 and the input/output unit 446.

The lexical representation DB 434 is a database for storing lexical representations generated by the lexical representation generation unit 422 and extraction query representations generated by the query representation generation unit 424.

The target search document DB 436 is a database for storing the target search documents that will be subject to word extraction. In embodiments, the target search document DB 436 may store target search documents input by the user via the user terminal 460 and the input/output unit 446.

The processor 444 is the processing unit for carrying-out processing instructions that define the function of each functional unit of the word extraction application 150 stored in the memory 420.

The input/output unit 446 is a functional unit for receiving information input to the word extraction device 410 and outputting information such as extraction information generated by the word extraction device 410. The input/output unit 446 may include, for example, a keyboard, a mouse, a display showing a graphical user interface (GUI), or the like. In embodiments, the query representation generation unit 424 may generate an extraction query representation based on user input received via the input/output unit 446.

The communication network 450 may include, for example, a local area network (LAN), wide area network (WAN), satellite network, cable network, WiFi network, or any combination thereof.

The user terminal 460 is a terminal device that can be used by a user of the word extraction device 410. By using the user terminal 460, the user can, for example, use the GUI provided by the input/output unit 446 to input training data, input information defining the extraction query representation, and check the extraction information output from the word extraction device 410. As an example, the user terminal 460 may include, but is not limited to, smartphones, smartwatches, tablets, personal computers, and the like.

For convenience of explanation, FIG. 4 illustrates a configuration including one user terminal 460 as an example, but the number of user terminals 460 is not limited.

According to the word extraction device 410 described above, it is possible to provide a word extraction technique that can improve the accuracy of word extraction by combining parsing techniques, such as syntactic parsing techniques and semantic parsing techniques, and leveraging the features of these multiple parsing techniques.

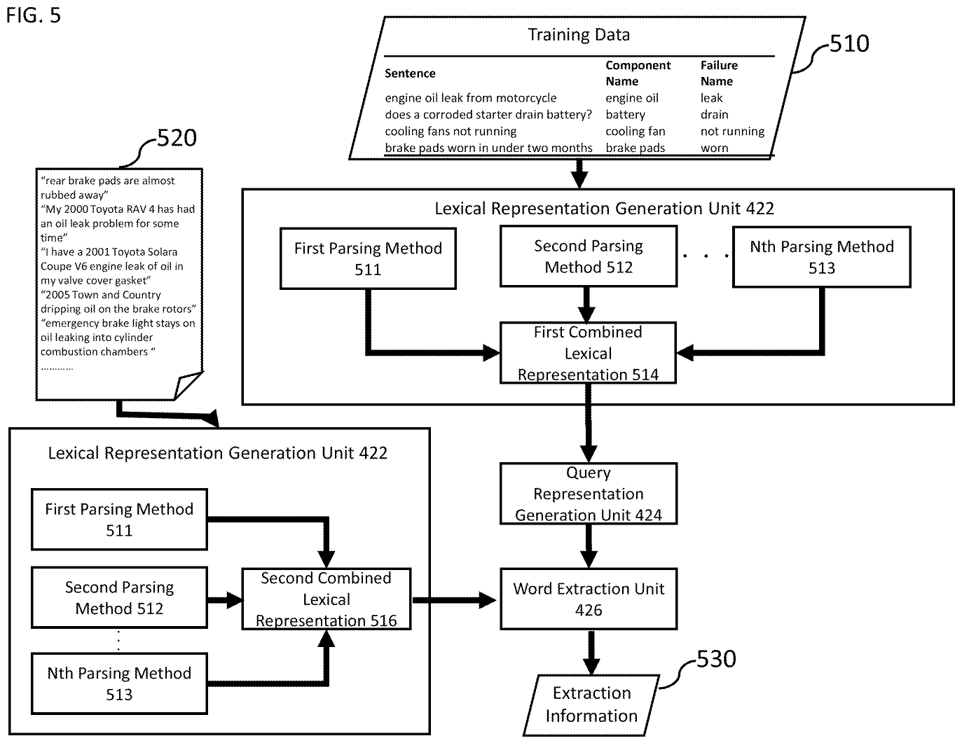

Next, with reference to FIG. 5, the functional configuration of a word extraction device according to the embodiments of the present disclosure will be described.

FIG. 5 illustrates the functional configuration of the word extraction device 410 according to the embodiments of the present disclosure. As described herein, the word extraction device 410 is a device for extracting extraction information including target extraction words from a given target search document using extraction rules generated by multiple parsing techniques, and as illustrated in FIG. 5, primarily includes a lexical representation generation unit 422, a query representation generation unit 424 and a word extraction unit 426.

First, the lexical representation generation unit 422 acquires the training data 510. This training data is information including sentences in which the target extraction words are specified. In embodiments, this training data 510 may include sentences to which flags identifying the target extraction words have been assigned. As an example, as illustrated in FIG. 5, this training data 510 may be information in which each of the target extraction words “cooling fan” as a component name and “not running” as a failure name have been specified with a flag in a sentence related to a component failure such as “cooling fans not running.”

After acquiring the training data 510, the lexical representation generation unit 422 processes the acquired training data 510 using multiple parsing techniques to generate multiple lexical representations corresponding to the training data 510. As mentioned above, a lexical representation as used herein may be a data structure that defines the words in the sentences included in the training data and the relationships between these words. This lexical representation may be a table, a matrix, a graph, or the like, for example. In the present disclosure, a case in which the lexical representation is in graph format will be used as an example. In a graph format lexical representation, words can be represented as nodes, and (syntactic or semantic) relationships between words can be represented as edges. These nodes are associated with node information indicating, for example, the words in the sentence, and these edges are associated with edge information indicating, for example, the relationships between words.

As an example, the lexical representation generation unit 422 may generate a first lexical representation by processing the training data 510 with a first parsing technique 511, generate a second lexical representation by processing the training data 510 with a second parsing technique 512, and generate an Nth lexical representation by processing the training data 510 with an Nth parsing technique 513. Here, the number and type of parsing techniques are not limited.

However, to generate highly accurate word extraction results that take into account both syntactic information and semantic information, it is desirable to use different parsing techniques, such as syntactic parsing techniques and semantic parsing techniques.

Next, after generating multiple lexical representations corresponding to the training data 510, the lexical representation generation unit 422 generates the first combined lexical representation 514 by aligning and combining the nodes and edges in the generated multiple lexical representations (the first lexical representation, the second lexical representation, . . . the Nth lexical representation) with each other.

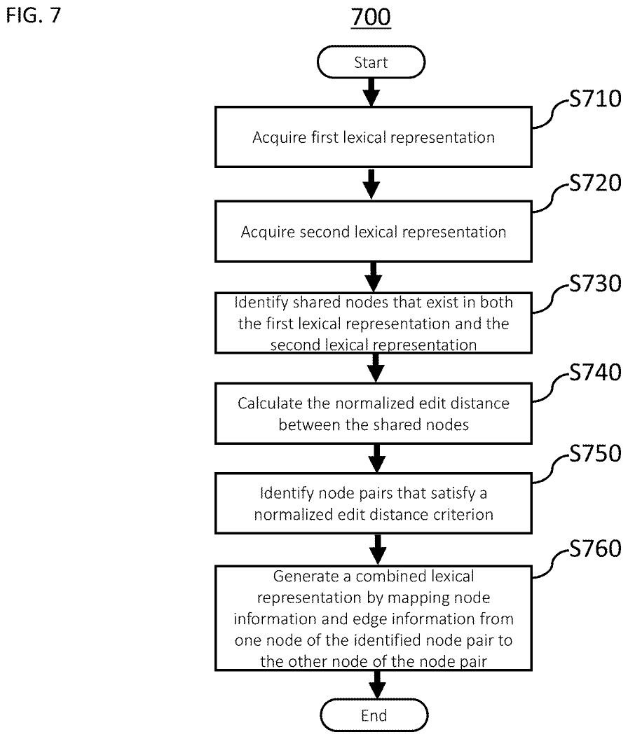

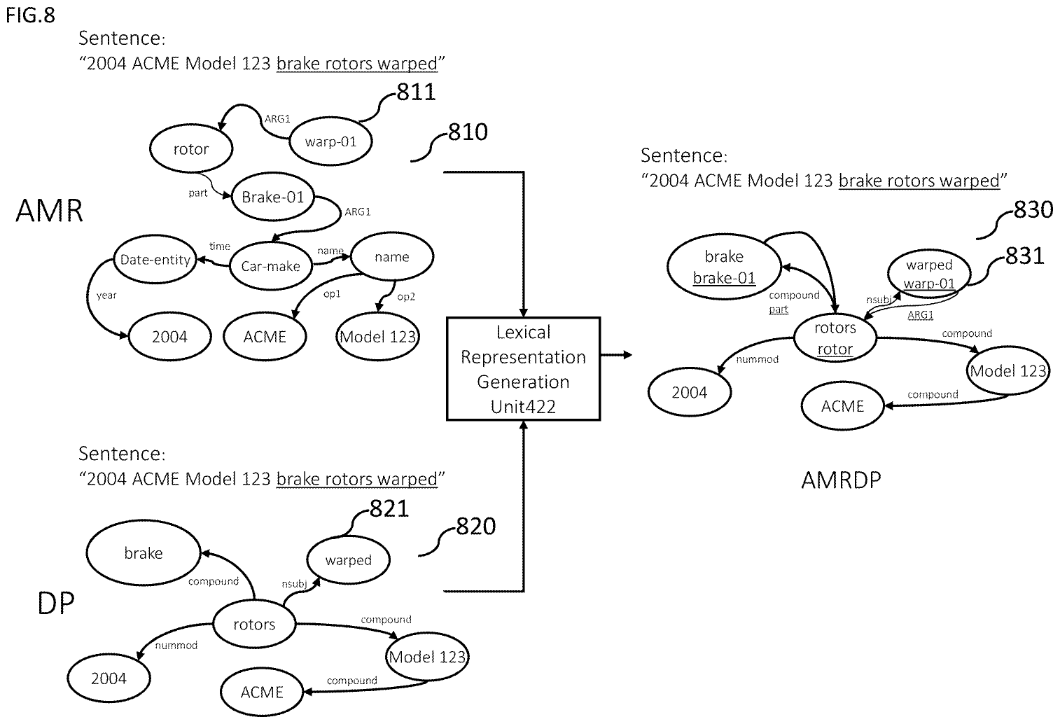

It should be noted that the process of aligning and combining nodes and edges in the lexical representations with each other is described below with reference to FIGS. 7-8, and is therefore omitted here.

Next, the query representation generation unit 424 generates an extraction query representation indicating a query for extracting the target extraction words from a given target search document based on the first combined lexical representation 514 generated by the lexical representation generation unit 422. As described above, this extraction query representation is a data structure that specifies rules for extracting the target extraction words, and may be in a graph format similar to the lexical representations. As an example, this extraction query representation may be a sub-graph (e.g., a sub-graph including the words and relations to be extracted) that represents a portion of the first combined lexical representation 514.

Here, the query representation generation unit 424 may generate the extraction query representation by processing the first combined lexical representation 514 with an automatic extraction rule generation technique, or by processing the first combined lexical representation 514 with a manual extraction rule generation technique. As described below, the extraction query representation generated here is used to extract the target extraction words from a given target search document.

In addition, the lexical representation generation unit 422 also acquires the target search document 520 from which the target extraction words are to be extracted. This target search document 520 is information containing sentences different from the training data 510, and may be input by the user via the user terminal 460 and the input/output unit 446 described above. Next, the lexical representation generation unit 422 processes the target search document 520 in the same manner as the training data 510, using multiple parsing techniques (e.g., the first parsing technique 511, the second parsing technique 512, and the Nth parsing technique 513) to generate multiple lexical representations corresponding to the target search document 520. Subsequently, these multiple lexical representations are combined to generate a second combined lexical representation 516.

It should be noted that the process of generating the second combined lexical representation 516 is substantially the same as the process of generating the first combined lexical representation 514, and is described below with reference to FIGS. 7-8, and as such the description thereof is omitted here. The multiple parsing techniques used to generate the second combined lexical representation 516 from the target search document 520 may be the same as or different from the multiple parsing techniques used to generate the second combined lexical representation 516 from the training data 510.

Next, the word extraction unit 426 uses the extraction query representation generated by the query representation generation unit 424 to search the second combined lexical representation 516 generated based on the target search document 520 to generate extraction information 530 that indicates information about the target extraction words. Here, the word extraction unit 426 may use any technique for searching the target search document 520 using the extraction query representation, such as OR Matching, AND Matching, matching based on the performance criteria of the parsing techniques, matching based on lexical attributes, or the like, as described below.

It should be noted that, as an example of a technique of the word extraction unit 426 searching the target search document 520 using the extraction query representation is described below, a description thereof will be omitted here.

According to the word extraction device 410 described above, it is possible to provide a word extraction technique that can improve the accuracy of word extraction by combining parsing techniques, such as syntactic parsing techniques and semantic parsing techniques, and leveraging the features of these multiple parsing techniques.

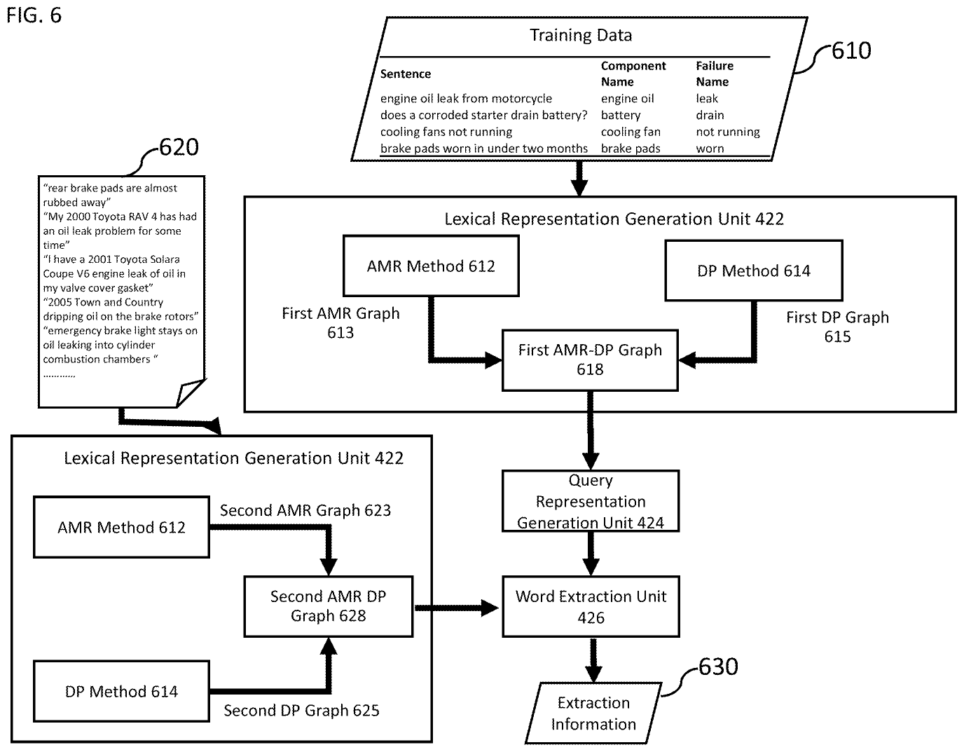

Next, with reference to FIG. 6, a functional configuration in which a DP technique and an AMR technique are used as parsing techniques in the word extraction device according to the embodiments of the present disclosure will be described.

As mentioned above, documents consisting of textual information in natural language contain syntactic information about the syntactic relationship of words and semantic information about the semantic relationship of words. When extracting words, it is desirable to consider both the syntactic information and the semantic information of the words.

In addition, as explained with reference to FIG. 5, the lexical representation generation unit 422 of the word extraction device 410 according to the embodiments of the present disclosure can generate multiple lexical representations corresponding to each of the training data and the target search document by processing each of the training data and the target search document using multiple parsing techniques. In this way, the word extraction device 410 can generate multiple lexical representations for each of the training data and the target search document.

Here, the lexical representation generation unit 422 may use semantic parsing techniques such as AMR techniques and syntactic parsing techniques such as DP techniques as the multiple parsing techniques for processing the training data and target search document.

This makes it possible to generate a combined lexical representation that includes both syntactic information and semantic information for the words in a sentence.

A case will be described below in which an AMR technique and a DP technique are used as the multiple parsing techniques for processing the training data and the search target document.

FIG. 6 is a diagram illustrating a functional configuration in which a DP technique and an AMR technique are used as parsing techniques in the word extraction device 410 according to the embodiments of the present disclosure.

First, after acquiring the training data 610, the lexical representation generation unit 422 generates a first AMR graph 613 by processing the acquired training data 610 using an AMR technique 612. In addition, the lexical representation generation unit 422 also generates a first DP graph 615 by processing the acquired training data 610 using a DP technique 614. Subsequently, the lexical representation generation unit 422 then generates a first AMR-DP graph 618 as a combined lexical representation (the first combined lexical representation) by aligning and combining the nodes and edges in the first AMR graph 613 and the first DP graph 615 with each other.

Next, the query representation generation unit 424 generates an extraction query representation indicating a query to extract the target extraction words from a given target search document based on the first AMR-DP graph 618 generated by the lexical representation generation unit 422.

In addition, the lexical representation generation unit 422 acquires the target search document 620 from which the target extraction words are to be extracted. Next, the lexical representation generation unit 422 generates a second AMR graph 623 by processing the target search document 620 using the AMR technique 612. In addition, the lexical representation generation unit 422 also generates a second DP graph 625 by processing the target search document 620 using the DP technique 614. The lexical representation generation unit 422 then generates a second AMR-DP graph 628 as a combined lexical representation (the second combined lexical representation) by aligning and combining the nodes and edges in the second AMR graph 623 and the second DP graph 625 with each other.

Next, the word extraction unit 426 uses the extraction query representation generated by the query representation generation unit 424 to search the second AMR-DP graph 628 generated based on the target search document 620 to generate extraction information 630 which indicates information about the target extraction words. Here, the word extraction unit 426 may use any technique for searching the target search document 620 using the extraction query representation, such as OR Matching, AND Matching, matching based on the performance criteria of the parsing techniques, matching based on lexical attributes, or the like as described below.

As explained above, by using a combination of semantic parsing techniques such as AMR techniques and syntactic parsing techniques such as DP techniques as the multiple parsing techniques for processing the training data and target search documents, it is possible to generate a combined lexical representation that includes both syntactic information and semantic information about the words in a sentence. Subsequently, by performing a search on such a lexical representation including syntactic information and semantic information, it is possible to obtain highly accurate word extraction results that consider both the syntactic information and the semantic information.

Next, with reference to FIG. 7, an example of the flow of a combination process according to the embodiments of the present disclosure will be described.

As described above, aspects of the present disclosure relate to generating a combined lexical representation that combines lexical representations generated by multiple parsing techniques. However, since lexical representations generated by different parsing techniques differ from each other in form, structure and content, the correspondence relationship of the information (e.g., node information and edge information) between each lexical representation is unknown.

Accordingly, aspects of the present disclosure relate to generating a combined lexical representation in which the syntactic and semantic information have been aligned by combining the nodes and edge information in multiple graph-format lexical representations after mapping them together.

FIG. 7 is a diagram illustrating an example of the flow of a combination process 700 according to the embodiments of the present disclosure. The combination process 700 is used to generate a combined lexical representation by aligning and combining the nodes and edges in multiple graph format lexical representations with each other. The combination process 700 may be used to generate a first combined lexical representation that combines multiple lexical representations generated based on training data, or a second combined lexical representation that combines multiple lexical representations generated based a target search document.

It should be noted that in the description of the combination process 700 illustrated in FIG. 7, a case in which DP and AMR graphs are combined may be used as an example, but this disclosure is not limited to this case, and lexical representations generated by other parsing techniques may also be used.

First, in Step S710, the lexical representation generation unit 422 acquires a first lexical representation. Here, the lexical representation generation unit 422 may use, for example, an AMR graph generated by processing the training data or the target search document using a semantic parsing technique such as an AMR technique as the first lexical representation. This first lexical representation may be a lexical representation in graph form, in which words in the training data or the target search document have been represented as nodes and the relationships between words have been represented as edges. Each node and each edge in the first lexical representation includes node information and edge information (first node information and first edge information) assigned by the parsing technique used to generate the first lexical representation.

Next, in Step S720, the lexical representation generation unit 422 acquires a second lexical representation. Here, the lexical representation generation unit 422 may use, for example, a DP graph generated by processing the training data or the target search document using a DP syntactic parsing technique as the second lexical representation. This second lexical representation may be a lexical representation in graph form, in which words in the training data or the target search document are represented as nodes and the relationships between words are represented as edges. Each node and each edge in the second lexical representation includes node information and edge information (second node information and second edge information) assigned by the parsing technique used to generate the second lexical representation.

Next, in Step S730, the lexical representation generation unit 422 identifies shared nodes that exist in both the first lexical representation and the second lexical representation. Here, a shared node refers to a node that exists in both the first lexical representation and the second lexical representation and relates to substantially similar node information. In embodiments, in a case that the first lexical representation is an AMR graph and the second lexical representation is a DP graph, the lexical representation generation unit 422 excludes from processing the nodes and edges in the DP graph that correspond to DP-specific words, and excludes from processing the nodes and edges that correspond to AMR-specific words. After excluding these nodes, the remaining nodes may be estimated to be shared nodes. Here, the lexical representation generation unit 422 may identify the nodes to be excluded by referring to a table or the like that indicates DP-specific words and AMR-specific words to be excluded.

As an example, the lexical representation generation unit 422 may exclude as targets from the DP graph nodes and edges corresponding to DP-specific words such as “would,” “should,” “have,” “on,” “in,” “from,” and prepositions and auxiliary verbs, and may exclude as targets from the AMR graph nodes and edges corresponding to AMR-specific words such as “date-entity,” “imperative,” “multi-sentence,” or the like.

Next, in Step S740, the lexical representation generation unit 422 calculates the normalized edit distance between the shared nodes identified in Step S730. More specifically, the lexical representation generation unit 422 calculates the normalized edit distance of each node in the first lexical representation with respect to each node in the second lexical representation. Normalized edit distance is a measure of sentence similarity and may be calculated by Equation 1 as shown below.

$$Normalized Edit Distance = \frac{edit\_distance ( node 1 , node 2 )}{maxlength ( node 1 , node 2 )} \qquad [ Equation 1 ]$$

Node1 and Node2 in Equation 1 are the nodes in the first lexical representation and the second lexical representation, respectively. “edit_distance” is used to calculate the edit distance between both nodes, and “maxlength” is used to obtain the longest character length of both nodes. It should be noted that although a case in which the normalized edit distance is used to calculate the similarity of the shared nodes is described here as an example, the present disclosure is not limited herein, and other similarity measures or similarity calculation techniques may be used.

In addition, in one embodiment, in the case that the first lexical representation is an AMR graph and the second lexical representation is a DP graph, the lexical representation generation unit 422 may omit calculating the normalized edit distance for nodes for which the correspondence relationship is known in advance.

Next, in Step S750, the lexical representation generation unit 422 identifies node pairs that satisfy a predetermined normalized edit distance criterion. In embodiments, the lexical representation generation unit 422 may identify as a node pair a first node in the first lexical representation and a second node in the second lexical representation whose normalized edit distance from the first node satisfies the normalized edit distance criterion.

In embodiments, the lexical representation generation unit 422 may vary the normalization edit distance criterion in steps from “0.0” to “0.9” (the lower the normalization edit distance, the greater the similarity between the nodes), allocate a confidence level according to the degree of normalized edit distance criterion that a node pair satisfies (i.e., give a higher confidence level to node pairs with lower normalized edit distances and a lower confidence level to node pairs with high normalized edit distances), and identify two nodes that satisfy a given confidence level as a node pair.

It should be noted that here, the lexical representation generation unit 422 may identify multiple node pairs.

In embodiments, in a case that the first lexical representation is an AMR graph and the second lexical representation is a DP graph, the lexical representation generation unit 422 may use the nodes whose correspondence relationship is already known as node pairs. As an example, the lexical representation generation unit 422 may set “amr-unknown” nodes in the AMR graph and “what,” “why,” “where,” “when,” and “how” nodes in the DP graph as node pairs. Similarly, the lexical representation generation unit 422 may set “-” nodes in the AMR graph and negative word nodes such as “not,” “no,” or “n′t” in the DP graph as node pairs. Here, the lexical representation generation unit 422 may identify node pairs by referring to a table or other information that indicates those nodes whose correspondence relationship is already known.

Next, in Step S760, for each node pair identified in Step S750, the lexical representation generation unit 422 generates a combined lexical representation by mapping the node and edge information of one node to the other node of the node pair.

As an example, in the case that a node pair including a first shared node in the first lexical representation and a second shared node in the second lexical representation is identified, the lexical representation generation unit 422 maps the node information (the second node information) and edge information (the second edge information) associated with the second shared node to the first shared node in the first lexical representation. By repeating this process for each node pair, a combined lexical representation can be generated.

According to the combination process 700 described above, node and edge information in one lexical representation can be assigned to corresponding nodes in another textual representation. In this way, it is possible to generate a combined lexical representation having a format in which the information of multiple lexical representations are aligned with each other.

Next, with reference to FIG. 8, an example of generating a combined lexical representation by combining a first lexical representation and a second lexical representation according to the embodiments of the present disclosure will be described.

As described herein, aspects of the present disclosure relate to generating a combined lexical representation by processing text such as training data or target search documents, for example, with multiple parsing techniques to generate multiple lexical representations corresponding to the text, and then combining these multiple lexical representations. FIG. 8 illustrates an example of generating a combined lexical representation 830 by combining a first lexical representation 810 and a second lexical representation 820 according to the embodiments of the present disclosure.

It should be noted that in the following, a case in which a Dependency Parsing (DP) technique and an Abstract Meaning Representation (AMR) technique are used as parsing techniques for generating lexical representations will be described as an example, but this disclosure is not limited to herein, and any parsing technique may be used.

First, consider that the lexical representation generation unit 422 inputs a sentence of “2004 ACME Model 123 brake rotors warped.” In this case, the lexical representation generation unit 422 generates an AMR graph as the first lexical representation 810 by processing the input sentence using a semantic parsing technique (a first parsing technique) such as an AMR technique. Additionally, the lexical representation generation unit 422 also generates a DP graph as the second lexical representation 820 by processing the sentence using a syntactic parsing technique (a second parsing technique) such as a DP technique.

As illustrated in FIG. 8, each node in the first lexical representation 810 and the second lexical representation 820 is associated with node information defining that node and edge information indicating the relationship between that node and other nodes.

The node information and the edge information in the first lexical representation 810 is semantic information assigned by the AMR technique used to generate the first lexical representation 810. As an example, in the first lexical representation 810, node 811 is associated with first node information of “warp-01” and first edge information of “ARG1.”

Similarly, the node information and the edge information in the second lexical representation 820 is syntactic information assigned by the DP technique used to generate the second lexical representation 820. For example, in the second lexical representation 820 illustrated in FIG. 8, node 821 is associated with second node information of “warped” and second edge information of “nsubj.”

As illustrated in FIG. 8, although both the first lexical representation 810 and the second lexical representation 820 are in a graph format in which words are represented as nodes and relationships between words are represented as edges, as the first lexical representation 810 was generated by a semantic parsing technique such as an AMR technique and the second lexical representation 820 was generated by a syntactic parsing technique such as a DP technique, there are places where the structure differs from each other. More specifically, the first lexical representation 810 generated by a semantic parsing technique such as AMR includes node information (date-entity, car-make, etc.) and edge information (year, time, part) regarding the semantic relationships between words that are not present in the second lexical representation 820, and the second lexical representation 820 generated by a syntactic parsing technique such as DP includes node information and edge information (compound, nsubj) regarding the syntactic relationships between words that are not present in the first lexical representation 810. In contrast, the first lexical representation 810 and the second lexical representation 820 also include node information corresponding to substantially similar content, such as “rotor, brake, warp.”

Accordingly, in order to combine the first lexical representation 810 and the second lexical representation 820, the first lexical representation 810 and the second lexical representation 820 must be aligned with each other.

Accordingly, as explained with reference to FIG. 7, the lexical representation generation unit 422 identifies shared nodes that are present in the second lexical representation 820, which is a DP graph, and also present in the first lexical representation 810, which is an AMR graph, calculates the normalized edit distance between shared nodes, identifies node pairs that satisfy a predetermined normalization edit distance criterion, and maps the node information and edge information of one node of the specified node pair to the other node of the node pair. In this way, an AMR-DP graph obtained by combining the first lexical representation 810 and the second lexical representation 820 can be generated as the combined lexical representation 830.

With reference to the first lexical representation 810 and the second lexical representations 820 illustrated in FIG. 8, an example of generating a combined lexical representation 830 will be described.

Consider that after applying the normalized edit distance criterion, node 811 in the first lexical representation 810 and node 821 in the second lexical representation 820 are identified as a node pair. In this case, the first node information “warp-01” and the first edge information “ARG1” associated with node 811 in the first lexical representation 810 are mapped to node 821 in the second lexical representation 820. As a result, as illustrated in the combined lexical representation 830, node 831 is associated with the second node information of “warped” and the second edge information of “nsubj” with which it was originally associated in the second lexical representation 820, as well as the first node information “warp-01” and the first edge information “ARG1” assigned from the first lexical representation 810.

By repeating this process for each node pair, the combined lexical representation 830 can be generated. It should be noted that, for convenience of explanation, in the drawings, the node and edge information assigned to the second lexical representation from the first lexical representation is illustrated with underlining.

In the above, a case of mapping the node and edge information of the first lexical representation to the nodes of the second lexical representation was described as an example, but the present disclosure is not limited to this case, and the node information and the edge information of the second lexical representation may be mapped to the nodes of the first lexical representation. Which lexical representation should serve as the source of the node information and edge information and which lexical representation should serve as the destination may be determined according to the characteristics of each lexical representation.

As an example, if one lexical representation is an AMR graph and another lexical representation is a DP graph, the DP graph includes information regarding the objective syntactic relationships between words, whereas the AMR graph includes information regarding subjective meanings as interpreted by the AMR technique. Accordingly, to facilitate a more reliable word extraction result, it is desirable to use the AMR graph as the source and the DP graph as the destination.

In this way, by combining a lexical representation generated by a syntactic parsing technique and a lexical representation generated by a semantic parsing technique, a combined lexical representation that includes both syntactic information and semantic information about the words in the sentence can be generated. Subsequently, as described below, by performing a search on the combined lexical representation generated in this way, it is possible to obtain highly accurate word extraction results that consider both the syntactic information and the semantic information.

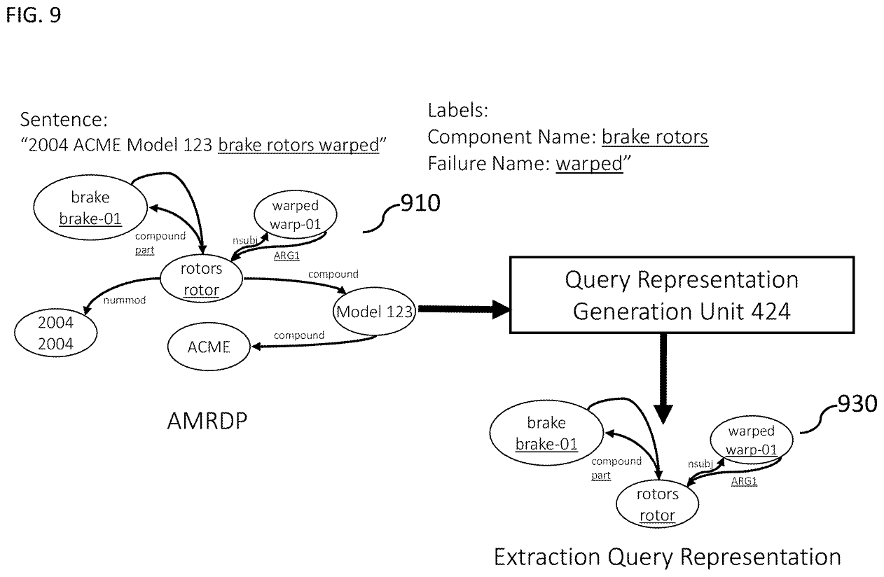

Next, with reference to FIG. 9, an example of generating an extraction query representation according to the embodiments of the present disclosure will be described.

FIG. 9 illustrates an example of generating an extraction query representation according to the embodiments of the present disclosure. As described above, the query representation generation unit 424 according to the embodiments of the present disclosure can generate an extraction query representation that indicates a query to extract target extraction words from a given target search document based on the combined lexical representation (the first combined lexical representation) generated by the lexical representation generation unit 422. In the following, an example will be described of the process of generating an extraction query representation in a case in which the combined lexical representation generated by the lexical representation generation unit 422 is an AMR-DP graph, which is a combination of an AMR graph and a DP graph.

As illustrated in FIG. 9, consider that an AMR-DP graph 910 corresponding to the sentence “2004 ACME Model 123 brake rotors warped” is generated as a combined lexical representation by the lexical representation generation unit 422 and input to the query representation generation unit 424. Also, consider that in this sentence, the component name “brake rotors” and the failure name “warped” are specified (labeled) as target extraction words.

In this case, the query representation generation unit 424 may generate the extraction query representation 930 by processing the AMR-DP graph 910 using an automatic extraction rule generation technique, or by processing the AMR-DP graph 910 using a manual extraction rule generation technique.

In the case of processing the AMR-DP graph 910 using an automatic extraction rule generation technique, the query representation generation unit 424 may, for example, determine the nodes identified as target extraction words in the AMR-DP graph 910, determine the edges connected to the determined nodes, and then generate the extraction query representation 930 by extracting a sub-graph including the determined nodes and edges from the AMR-DP graph 910.

When processing the AMR-DP graph 910 using a manual extraction rule generation technique, the query representation generation unit 424 may generate the extraction query representation 930 based on user input that has been input to a GUI provided by the input/output unit 446 to the user terminal 460. For example, if the query representation generation unit 424 receives a user input specifying a subgraph including nodes and edges corresponding to target extraction words in the AMR-DP graph 910, it may generate the extraction query representation 930 by extracting the specified subgraph from the AMR-DP graph 910.

As an example, as illustrated in FIG. 9, the query representation generation unit 424 generates the extraction query representation 930 by extracting from the AMR-DP graph 910 a subgraph including nodes and edges corresponding to the component name “brake rotors” and the failure name “warped” that were identified as target extraction words.

It should be noted that as the query representation generation unit 424 extracts the subgraph from a combined lexical representation that contains both node and edge information (e.g., the first node information and the first edge information) assigned by the first parsing technique used to generate the first lexical representation and node and edge information (e.g., the second node information and the second edge information) assigned by the second parsing technique used to generate the second lexical representation, similar to the combined lexical representation, this subgraph extracted as the extraction query representation also includes both node information and edge information from the first lexical representation and the second lexical representation (the first node information, the first edge information, the second node information, and the second edge information).

In this way, it is possible to generate an extraction query representation that functions as a rule for extracting target extraction words from a combined lexical representation, which is a combination of multiple lexical representations generated by multiple parsing techniques.

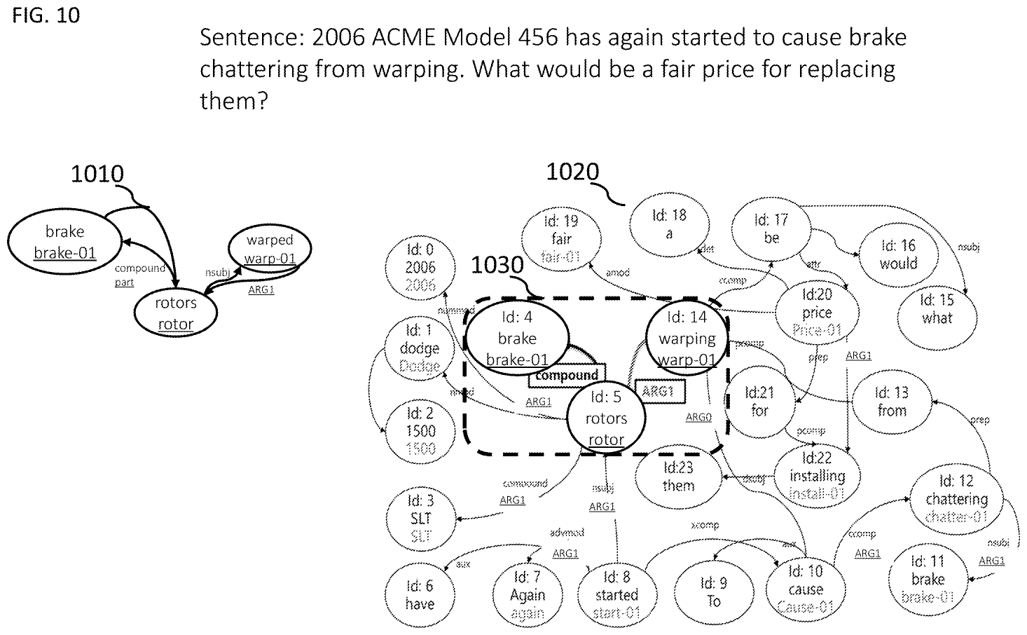

As described above, the word extraction unit 426 according to the embodiments of the present disclosure can generate extraction information indicating information regarding the target extraction words by using the extraction query representation generated by the query representation generation unit 424 to perform a graph search on a combined lexical representation (e.g., an AMR-DP graph; also referred to herein as a second combined lexical representation) generated based on a target search document. Here, the word extraction unit 426 may use any search technique to search the combined lexical representation using the extraction query representation, such as OR Matching, AND Matching, matching based on the performance criteria of the parsing techniques, matching based on lexical attributes, or the like, and is not limited to any particular technique. In the following, with reference to FIG. 10 to FIG. 14, examples of a graph search techniques used by the word extraction unit according to the embodiments of the present disclosure will be described.

It should be noted that, in the following, although a case in which the combined lexical representation is an AMR-DP graph generated based on the sentence “2006 ACME Model 456 has again started to cause brake chattering from warping. What would be a fair price for replacing them?” will be illustrated as an example, the present disclosure is not limited herein.

FIG. 10 is a diagram illustrating an example of a case where AND/OR matching is used as a graph search technique according to the embodiments of the present disclosure. FIG. 10 illustrates a case in which AND/OR matching is implemented with respect to the extraction query representation 1010 and the second combined lexical representation 1020 illustrated in FIG. 10 as an example.

As described above, like the first combined lexical representation, the extraction query representation 1010 generated from the first combined lexical representation includes first node information (warped-01, brake-01, rotor) and first edge information (ARG1, part) assigned by a first parsing technique such as an AMR technique and second node information (warped, brake, rotors) and second edge information (nsubj, compound) assigned by a second parsing technique such as a DP technique.

Similarly, like the first combined lexical representation, the second combined lexical representation 1020 includes third node information (warp-01, brake-01, rotor) and third edge information (ARG1) assigned by a first parsing technique, such as an AMR technique, and fourth node information (warning, brake, rotors) and fourth edge information (compound) assigned by a second parsing technique, such as a DP technique.

The word extraction unit 426 may use OR matching as a technique for searching the second combined lexical representation 1020 generated based on the target search document using the extraction query representation 1010 generated by the query representation generation unit 424. In the case of using this OR matching, when the word extraction unit 426 compares the extraction query representation 1010 and the second combined lexical representation 1020, in the case that it is determined that either one of the information assigned by the first parsing technique (the node information and the edge information) or the information assigned by the second parsing technique (the node information and the edge information) satisfies a predetermined matching condition between the extraction query representation 1010 and the second combined lexical representation 1020, the word extraction unit 426 extracts the node information and the edge information determined to satisfy the matching condition as the extraction information.

It should be noted that here, the matching condition is a condition that specifies a predetermined degree of similarity of the node and edge information, and may be based on, for example, the normalized edit distance or other similarity measure described above.

An example of OR matching is illustrated using the extraction query representation 1010 and the second combined lexical representation 1020 illustrated in FIG. 10.

Consider that the word extraction unit 426 compares the extraction query representation 1010 with the second combined lexical representation 1020. In this case, in the case that the word extraction unit 426 determines that either one of the first node information (warp-01, brake-01, rotor) or the second node information (warped, brake, rotors) of each node in the extraction query representation 1010 satisfies the matching condition with respect to either one of the third node information (warp-01, brake-01, rotor) or the fourth node information (warping, brake, rotors) of a specific node in the second combined lexical representation 1020, and either one of the first edge information (ARG1, part) or the second edge information (nsubj, compound) of each node in the extraction query representation 1010 satisfies the matching condition with respect to either one of the third edge information (ARG1) or the fourth edge information (compound) of a specific node in the second combined lexical representation 1020, the word extraction unit 426 extracts the third node information, the fourth node information, the third edge information, and the fourth edge information of the specific node from the second combined lexical representation 1020 as the extraction information.

In addition, the word extraction unit 426 may use AND matching as a technique for searching the second combined lexical representation 1020 generated based on the target search document using the extraction query representation 1010 generated by the query representation generation unit 424. In the case of using this AND matching, when the word extraction unit 426 compares the extraction query representation 1010 and the second combined lexical representation 1020, in the case that it is determined that both of the information assigned by the first parsing technique (the node information and the edge information) and the information assigned by the second parsing technique (the node information and the edge information) satisfy a predetermined matching condition between the extraction query representation 1010 and the second combined lexical representation 1020, the word extraction unit 426 extracts the node information and the edge information determined to satisfy the matching condition as the extraction information.

An example of AND matching is illustrated using the extraction query representation 1010 and the second combined lexical representation 1020 illustrated in FIG. 10.

Consider that the word extraction unit 426 compares the extraction query representation 1010 with the second combined lexical representation 1020. In this case, in the case that the word extraction unit 426 determines that both of the first node information (warp-01, brake-01, rotor) and the second node information (warped, brake, rotors) of each node in the extraction query representation 1010 satisfies the matching condition with respect to both of the third node information (warp-01, brake-01, rotor) and the fourth node information (warping, brake, rotors) of a specific node in the second combined lexical representation 1020, and both of the first edge information (ARG1, part) and the second edge information (nsubj, compound) of each node in the extraction query representation 1010 satisfy the matching condition with respect to both of the third edge information (ARG1) and the fourth edge information (compound) of a specific node in the second combined lexical representation 1020, the word extraction unit 426 extracts the third node information, the fourth node information, the third edge information, and the fourth edge information of the specific node from the second combined lexical representation 1020 as the extraction information.

In the case that OR matching is performed on the extraction query representation 1010 and the second combined lexical representation 1020 illustrated in FIG. 10, as one of the node information and edge information assigned by the first parsing technique or the node information and edge information assigned by the second parsing technique matches between the extraction query representation 1010 and the second combined lexical representation 1020, the subgraph 1030 illustrated in FIG. 10 is extracted as the extracted information.

On the other hand, in the case that AND matching is performed on the extraction query representation 1010 and the second combined lexical representation 1020 illustrated in FIG. 10, as the second node information of “warped” in the extraction query representation 1010 does not match the fourth node information of “warping” in the second combined lexical representation 1020, extraction information is not extracted.

In the case that OR matching as described above is used as a technique for searching the combined lexical representations, word extraction results with favorable recall rates can be obtained. In addition, in the case that the AND matching as described above is used as a technique for searching the combined lexical representations, although the recall rate decreases, word extraction results with favorable precision can be obtained. The word extraction results obtained by OR matching can be used as training data for a learning model in which a certain amount of noise is tolerated, for example. In addition, AND matching results can be used as training data for a learning model that requires high precision, for example.

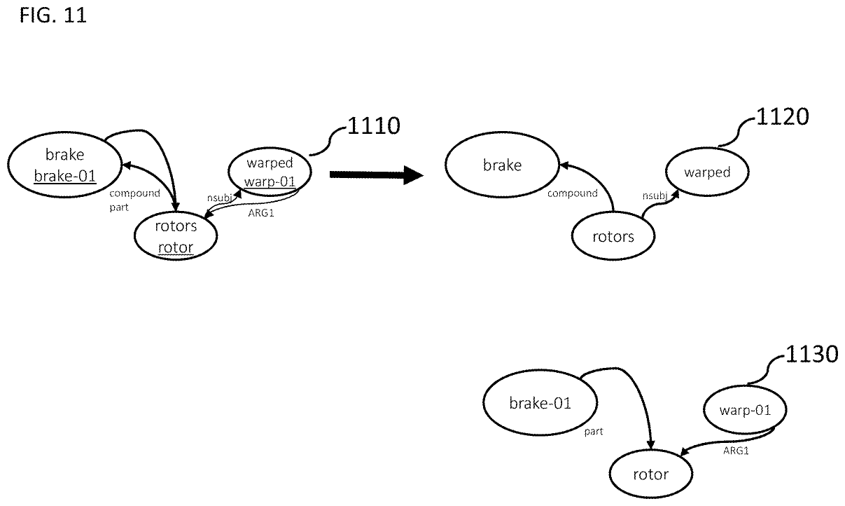

FIG. 11 is a diagram illustrating an example of a case where matching based on performance criteria of the parsing techniques is used as a graph search technique according to the embodiments of the present disclosure.

As described herein, in the case of an AMR-DP graph generated by combining an AMR graph and a DP graph, the AMR-DP graph includes both node information (the first node information) and edge information (the first edge information) assigned by the AMR technique and node information (the second node information) and edge information (the second edge information) assigned by the DP technique.

When searching a combined lexical representation using an extraction query representation, the extracted information that serves as the search result may differ depending on whether the search is performed using the node information and edge information provided by the AMR technique or the search is performed using the node information and edge information provided by the DP technique. This is because the result of the graph search is affected by the performance characteristics of each of the parsing techniques, such as AMR and DP techniques. As an example, in the case that the search is performed using the node and edge information assigned by the AMR technique, the recall tends to be high, but the precision tends to be low. In contrast, in the case that the search is performed using the node and edge information assigned by the DP technique, the precision tends to be high, but the recall tends to be low.

Accordingly, in embodiments, the word extraction unit 426 according to the embodiments of the present disclosure relates to determining, based on the performance characteristics of the parsing techniques, whether to perform the search using the node information and the edge information assigned by the first parsing technique or to perform the search using the node information and the edge information assigned by the second parsing technique.

For example, in the case that the performance (the recall rate, the precision rate) of the first parsing technique meets a predetermined performance criterion, the word extraction unit 426 performs a search on the combined lexical representation using the node information (the first node information) and the edge information (the first edge information) assigned by this first parsing technique.

In contrast, in the case that the performance (the recall rate, the precision rate) of the second parsing technique meets a predetermined performance criterion, the word extraction unit 426 performs a search on the combined lexical representation using the node information (the second node information) and edge information (the second edge information) assigned by this second parsing technique.

The performance criterion here may be, for example, information indicating whether priority is given to recall rate or precision rate, and may be entered by the user via the user terminal 460.

As an example, consider that a graph search is performed on a combined lexical representation (for example, an AMR-DP graph) generated based on the target search document using the AMR-DP graph 1110 generated by the query representation generation unit 424 as an extracted query representation. In this case, if the performance of the AMR technique meets the predetermined performance criterion, the word extraction unit 426 may perform the graph search using a subgraph 1120 including node information (the first node information) and edge information (the first edge information) assigned by the AMR technique in the AMR-DP graph 1110.

In contrast, if the performance of the DP technique meets the specified performance criterion, the word extraction unit 426 may perform the graph search using a subgraph 1120 including node information (the second node information) and edge information (the second edge information) assigned by the DP technique in the AMR-DP graph 1110.

More particularly, in the case that the performance of the first parsing technique satisfies a first performance criterion, when comparing the extraction query representation and the second combined lexical representation, in the case that the word extraction unit 426 determines that the first node information of each node in the extraction query representation satisfies a matching condition with respect to the third node information of the first node in the second combined lexical representation, and the first edge information of each node in the extraction query representation satisfies a matching condition with respect to the third edge information of the first node in the second combined lexical representation, the word extraction unit 426 extracts the third node information and the third edge information of the first node from the second combined lexical representation as the extraction information.

In contrast, in the case that the performance of the second parsing technique satisfies a second performance criterion, in the case that the word extraction unit 426 determines that the second node information of each node in the extraction query representation satisfies a matching condition with respect to the fourth node information of the first node in the second combined lexical representation, and the second edge information of each node in the extraction query representation satisfies a matching condition with respect to the fourth edge information of the first node in the second combined lexical representation, the word extraction unit 426 extracts the fourth node information and the fourth edge information of the first node from the second combined lexical representation as the extraction information.

By performing matching based on the performance criterion for the parsing techniques as described above, it is possible to perform graph searches that utilize the unique performance characteristics of the parsing techniques, such as graph searches that prioritize recall or graph searches that prioritize precision, and word extraction accuracy can be increased.

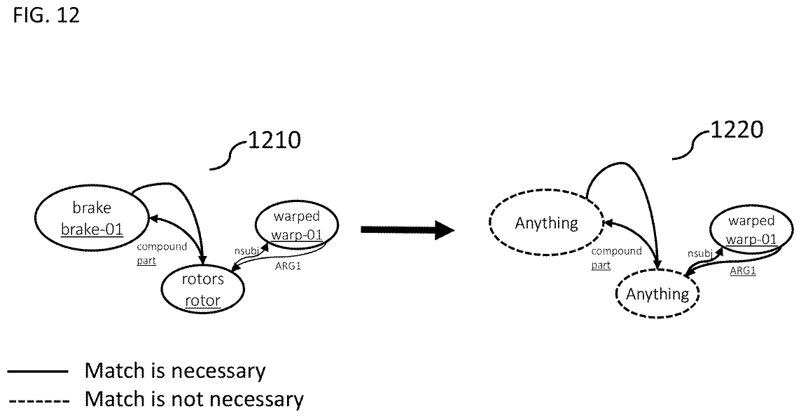

FIG. 12 is a diagram illustrating an example of a case where a matching necessity criterion is used as a graph search technique according to the embodiments of the present disclosure.

In embodiments, the word extraction unit 426 may perform a graph search based on a pre-specified matching necessity criterion. This matching necessity criterion is information indicating the nodes and edges that need to match and the nodes and edges that do not need to match between the extraction query representation and the combined lexical representation when performing a graph search, and may be entered by the user, for example, via user terminal 460.

More specifically, in the case that the word extraction unit 426 receives matching necessity information defining the matching necessity criterion that defines the nodes and edges that need to match and the nodes and edges that do not need to match between the extraction query representation and the combined lexical representation, the word extraction unit 426 compares the extraction query representation and the combined lexical representation, identifies specific nodes in the combined lexical representation that satisfy the matching necessity criterion, and extracts the node information and the edge information of the identified nodes from the combined lexical representation as the extraction information.

For example, consider that an AMR-DP graph consisting of three nodes, “brake/brake-01”, “rotors/rotor” and “warped/warp-01,” is generated as an extraction query representation 1210 as illustrated in FIG. 12. In this case, consider that a matching necessity criterion is received from a user or the like indicating that, although the node “warped/warp-01” and the edges “compound/part” and “nsubj/Arg1” must match between extraction query representation and the combined lexical representation, the node information of the nodes connected to this node may be anything.

In this case, when the word extraction unit 426 performs a graph search with respect to the combined lexical representation using the extraction query representation 1210, if there are nodes and edges in the combined lexical representation that match the “warped/warp-01” node, the “compound/part” edge and the “nsubj/Arg1” edge, this node and edge information is extracted as the extraction information 1220 even if the node information of other nodes connected to these nodes do not match the extraction query representation 1210.

According to the graph search based on the matching necessity criterion described above, it is possible to search for specific nodes and edges selected by a user. For example, in the case that a user wants to identify all the components related to a specific failure in a document related to component failures, by defining a matching necessity criterion that requires matching only for node information indicating failure names and edge information indicating the relationship between the failure and the component, it is possible to extract component names that have the defined relationship and are associated with the specified failure from a target document.

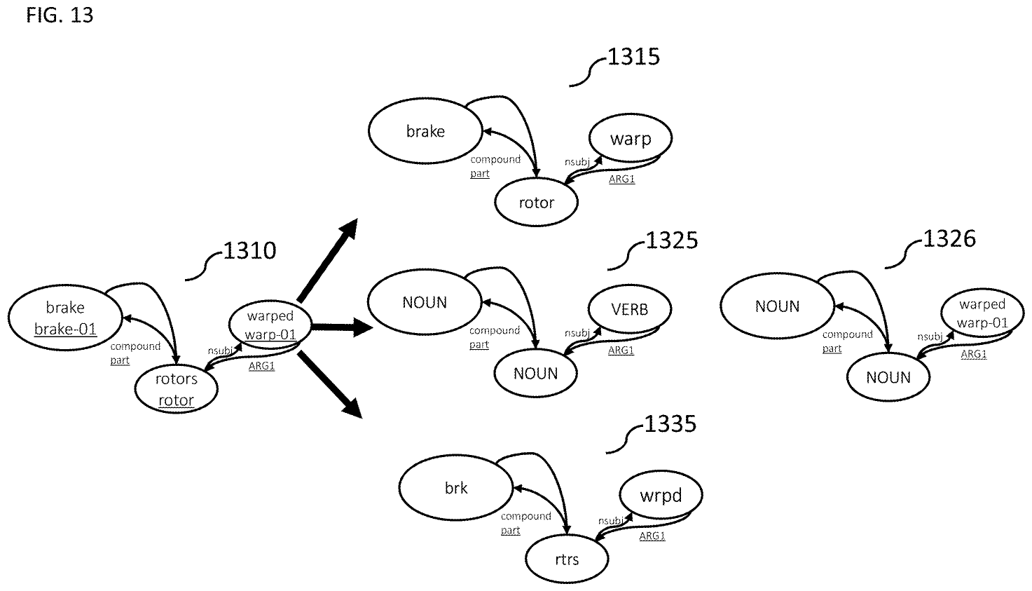

FIG. 13 is a diagram illustrating an example of a case where lexical attribute information is used as a graph search technique according to the embodiments of the present disclosure.

In embodiments, the word extraction unit 426 may perform a graph search based on lexical attribute information that indicates the lexical attributes of words. Here, the lexical attributes may include, but are not limited to, the lemma, part of speech, or consonants of a word. In some embodiments, this lexical attribute information may be entered by the user via user terminal 460.

More specifically, in the case that lexical attribute information indicating a predetermined lexical attribute is received, the word extraction unit 426 compares the extraction query representation and the combined lexical representation, identifies a specific node in the combined lexical representation having a lexical attribute indicated by the lexical attribute information that matches between the extraction query representation and the second combined lexical representation, and extracts the node information and the edge information of the identified node from the combined lexical representation as the extraction information.

In the following, an example of a graph search performed with lexical attribute information using the extraction query representation 1310 illustrated in FIG. 13 will be described.

In the case that lexical attribute information specifying “lemma” as the lexical attribute of a word is received, the word extraction unit 426 may generate a modified extraction query representation 1315 in which the word that serves as the node information for a particular node in the extraction query representation 1310 is converted to the lemma of that word (for example, the word “warped” is converted to its lemma of “warp”).

In the case that lexical attribute information specifying “part of speech” as the lexical attribute of a word is received, the word extraction unit 426 may generate a modified extraction query representation 1325 in which the word that serves as the node information for a particular node in the extraction query representation 1310 is converted to the part of speech of that word (for example, “brake” and “rotors” are indicated as “nouns” and “warped” is shown as a “verb”).

Here, as illustrated in FIG. 13, it is not necessary to convert all the node information in the extraction query representation 1310 to their respective parts of speech, but rather, as in the modified extraction query representation 1326, it is possible to combine nodes whose node information is the original node information with nodes whose node information is its part of speech.

In the case that lexical attribute information specifying “consonant” as the lexical attribute of a word is received, the word extraction unit 426 may generate a modified extraction query representation 1335 in which the word that serves as the node information for a particular node in the extraction query representation 1310 is converted to the consonants in that word (e.g., “brake”, “rotors” and “warped” are indicated as “brk”, “rtrs” and “wrpd”, respectively).

By using the lexical attribute information described above to perform the graph search, nodes with specific lexical attributes in common can be extracted from the combined lexical representation, thus enabling highly accurate word extraction.

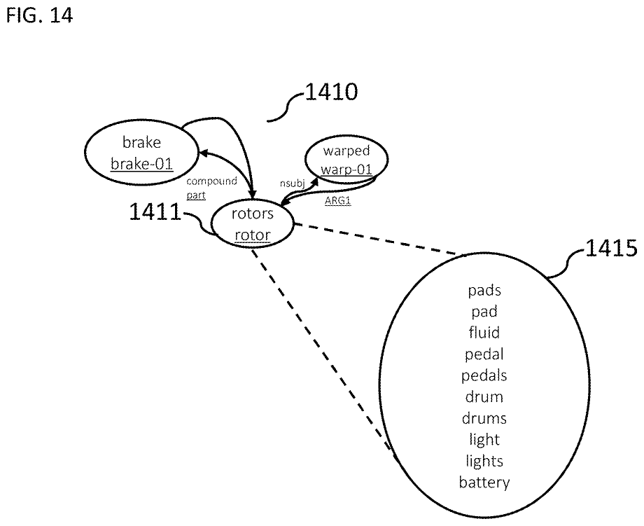

FIG. 14 is a diagram illustrating an example of a case where related terms are used as a graph search technique according to the embodiments of the present disclosure.

As described above, in the combined lexical representations generated based on the extraction query representation and the target search document, nodes are associated with node information, and edges are associated with edge information. For example, the nodes in the extraction query representation 1410 illustrated in FIG. 14 are associated with node information corresponding to target extraction words, such as “brake,” “rotors,” and “warped,” and the edges between these nodes are associated with edge information indicating the relationships between the target extraction words, such as “part” and “nsubj.”

As described above, in general, the comparison of the extraction query representations and the combined lexical representations is based on the similarity of their node and edge information. As a result, even if the node and edge information substantially correspond to each other, the extraction query representations and the combined lexical representations may be determined not to match each other due to differences in notation or nomenclature, and the target extraction words may not be accurately determined.

Accordingly, in an embodiment of the present disclosure, the word extraction unit 426 may assign information (for example, fifth node information and fifth edge information) indicating related terms to each of the node information and the edge information included in the extraction query representation, and perform a graph search including the related terms. This information indicating the related terms may be entered by the user via the user terminal 460, or it may be automatically generated based on a predetermined thesaurus.

More specifically, in the case that the word extraction unit 426 receives fifth node information (or fifth edge information) that indicates the related terms of a specific node in the query representation, the word extraction unit 426 compares the extraction query representation and the combined lexical representation, and if it determines that the fifth node information (or the fifth edge information) of a specific node in the extraction query representation satisfies the matching condition with respect to either one of the third node information or the fourth node information (or the third edge information or the fourth edge information) of a specific node in the combined lexical representation, the third node information, the fourth node information, the third edge information, and the fourth edge information of the node determined to satisfy the matching condition may be extracted from the combined lexical representation as the extraction information.

As an example, the word extraction unit 426 may assign related terms such as “pads,” “drum,” “fluid” or the like as node information 1415 with respect to the node information 1411 of “rotors/rotor” in the extraction query representation 1410.

Subsequently, when searching the combined lexical representation using the extraction query representation 1410, if it is determined that the node information of a node in the combined lexical representation corresponds to any of the information included in the node information 1411 of “rotors/rotor” or in the node information 1415 indicating the related terms, the information of nodes or edges connected this node may be extracted as the extraction information.

According to the graph search technique using the related terminology described above, it is possible to prevent determination errors due to differences in notation or nomenclature of node information and edge information, and thus improve the accuracy of word extraction.

As mentioned above, documents consisting of textual information in natural language contain syntactic information about the syntactic relationship of words and semantic information about the semantic relationship of words. When extracting words from a given search target document, it is desirable to consider both the syntactic information and the semantic information of the words.

However, conventional LKE techniques perform word extraction using extraction rules generated by a single parsing technique, which limits the accuracy of word extraction because it cannot generate extraction rules that take into account both syntactic parsing information and the semantic information in the target search document.

Accordingly, the present disclosure relates to performing word extraction using extraction rule representations based on combined lexical representations generated by aligning and combining multiple lexical representations generated by multiple parsing techniques with each other. For example, by aligning and combining a lexical representation generated by a syntactic parsing technique such as a DP technique and a lexical representation generated by a semantic parsing technique such as an AMR technique, a combined lexical representation including both syntactic and semantic information can be obtained. Subsequently, by using an extraction rule representation based on the combined lexical representation generated in this way, highly accurate word extraction that takes into account both syntactic and semantic information becomes possible.

Further, by using OR Matching, AND Matching, matching based on the performance criteria of the parsing techniques, and matching based on lexical attributes as the graph search technique according to the embodiments of the present disclosure, flexible and granular graph search can be performed to meet the needs of the user.

It should be noted that, herein, although examples were described of a case in which a lexical representation generated by a syntactic parsing technique such as a DP technique and a lexical representation generated by semantic parsing technique such as an AMR technique were combined, the present invention is not limited herein, and it is possible combine lexical representations generated by multiple syntactic parsing techniques or lexical representations generated by multiple semantic parsing techniques for example. As a result, information that is not included in one lexical representation can be supplemented with other lexical representations, for example.

The word extraction techniques according to the embodiments of the present disclosure may be applied in any field. For example, the word extraction technique according to the embodiments of the present disclosure may be applied to radiation reports used for radiation therapy. In this case, the word extraction technique according to the embodiments of the present disclosure may be used to extract information regarding an abnormality described in a radiation report and the area where this abnormality was found. As an example, the word extraction technique according to the embodiment of the present disclosure may extract information regarding an abnormality of “abnormal flare signal intensity” and information regarding an area of “brain parenchyma” from the sentence “abnormal flare signal intensity in the brain parenchyma”.

In addition, the word extraction techniques according to the embodiments of the present disclosure may be applied to a cyber attack report or blog concerning a cyber attack. In this case, the word extraction technique according to the embodiments of the present disclosure may be used to extract information regarding the attack means, malware name, target product, or the like described in the cyber attack report. As an example, the word extraction technique according to the embodiments of the present disclosure may extract “Bisonal” as malware and “RAT (Remote Access Trojan)” as the type of the malware from the sentence “Bisonal is a RAT (Remote Access Trojan).

As described herein, the word extraction technique according to the embodiments of the present disclosure includes the following aspects.
(Aspect 1)
A word extraction device comprising:
   a processor; and
   a memory,
wherein the memory includes processing instructions for causing the processor to function as:
   a lexical representation generation unit for acquiring training data that includes sentences in which target extraction words are specified, generating a first lexical representation by processing the training data with a first parsing technique, generating a second lexical representation by processing the training data with a second parsing technique, and generating a first combined lexical representation by combining the first lexical representation and the second lexical representation;
   a query representation generation unit for generating, based on the first combined lexical representation, an extraction query representation that indicates a query for extracting the target extraction words from a predetermined target search document; and
   a word extraction unit for extracting, by using the extraction query representation, extraction information that indicates information about the target extraction words from a second combined lexical representation generated based on the target search document.
(Aspect 2)
The word extraction device according to aspect 1, wherein:
   the first parsing technique is an Abstract Meaning Representation technique; and
   the second parsing technique is a Dependency parsing technique.
(Aspect 3)
The word extraction device according to aspect 1 or 2, wherein:
   the first lexical representation, the second lexical representation, the first combined lexical representation, the second combined lexical representation, and the extraction query representation have a graph structure in which words are represented as nodes, and relationships between words are represented as edges.
(Aspect 4)
The word extraction device according to aspect 3, wherein:
   each node in the first lexical representation is associated with first node information and first edge information from the first parsing technique;
   each node in the second lexical representation is associated with second node information and second edge information from the second parsing technique; and
   the lexical representation generation unit:
      compares a first node in the first lexical representation with a second node in the second lexical representation, and identifies nodes shared between the first lexical representation and the second lexical representation as shared nodes; and
      generates the first combined lexical representation by mapping the first node information and the first edge information associated with a first shared node among the shared nodes to a second shared node among the shared nodes in the second lexical representation.
(Aspect 5)
The word extraction device according to aspect 4, wherein, in generation of the first combined lexical representation, the lexical representation generation unit:
   calculates a normalized edit distance between nodes in the first lexical representation and nodes in the second lexical representation; and
   identifies nodes that satisfy a predetermined normalized edit distance criterion as the shared nodes.
(Aspect 6)
The word extraction device according to aspect 4, wherein:
the query representation generation unit generates a subgraph representing a portion of the first combined lexical representation as the extraction query representation.
(Aspect 7)
The word extraction device according to aspect 6, wherein the lexical representation generation unit:
   generates a third lexical representation by processing the target search document using the first parsing technique, generates a fourth lexical representation by processing the target search document using the second parsing technique, and generates the second combined lexical representation by combining the third lexical representation and the fourth lexical representation; and
   each node in the second combined lexical representation is associated with third node information and third edge information from the first parsing technique and fourth node information and fourth edge information from the second parsing technique.
(Aspect 8)
The word extraction device according to aspect 7, wherein the word extraction unit:
   compares the extraction query representation with the second combined lexical representation; and
   extracts, in a case that it is determined that either one of the first node information or the second node information of each node in the extraction query representation satisfies a matching condition with respect to either one of the third node information or the fourth node information of a first node in the second combined lexical representation, and either one of the first edge information or the second edge information of each node in the extraction query representation satisfies a matching condition with respect to either one of the third edge information or the fourth edge information of the first node in the second combined lexical representation, the third node information, the fourth node information, the third edge information, and the fourth edge information of the first node from the second combined lexical representation as the extraction information.
(Aspect 9)
The word extraction device according to aspect 7 or 8, wherein the word extraction unit:
   compares the extraction query representation with the second combined lexical representation; and
   extracts, in a case that it is determined that both of the first node information and the second node information of each node in the extraction query representation satisfies a matching condition with respect to the third node information and the fourth node information of a first node in the second combined lexical representation, and both of the first edge information and the second edge information of each node in the extraction query representation satisfy a matching condition with respect to the third edge information and the fourth edge information of the first node in the second combined lexical representation, the third node information, the fourth node information, the third edge information, and the fourth edge information of the first node from the second combined lexical representation as the extraction information.
(Aspect 10)
The word extraction device according to any one of aspects 7 through 9, wherein:
   in a case that a performance of the first parsing technique satisfies a first performance criterion, the word extraction unit:
      compares the extraction query representation with the second combined lexical representation, and
      extracts, in a case that it is determined that the first node information of each node in the extraction query representation satisfies a matching condition with respect to the third node information of a first node in the second combined lexical representation and the first edge information of each node in the extraction query representation satisfies a matching condition with respect to the third edge information of the first node in the second combined lexical representation, the third node information and the third edge information of the first node from the second combined lexical representation as the extraction information; and
   in a case that a performance of the second parsing technique satisfies a second performance criterion, the word extraction unit:
      extracts, in a case that it is determined that the second node information of each node in the extraction query representation satisfies a matching condition with respect to the fourth node information of the first node in the second combined lexical representation and the second edge information of each node in the extraction query representation satisfies a matching condition with respect to the fourth edge information of the first node in the second combined lexical representation, the fourth node information and the fourth edge information of the first node from the second combined lexical representation as the extraction information.
(Aspect 11)
The word extraction device according to any one of aspects 7 through 10, wherein in a case that matching necessity information is received that defines a matching necessity criterion defining nodes and edges that need to match and nodes and edges that do not need to match between the extraction query representation and the second combined lexical representation, the word extraction unit:
   compares the extraction query representation with the second combined lexical representation; and
   identifies a first node in the second combined lexical representation that satisfies the matching necessity criterion; and
   extracts node information and edge information of the first node from the second combined lexical representation as the extraction information.
(Aspect 12)
The word extraction device according to any one of aspects 7 through 11, wherein in a case that fifth node information is received that indicates related terms of a second node in the extraction query representation, the word extraction unit:
   compares the extraction query representation with the second combined lexical representation; and
   extracts, in a case that the fifth node information of the second node in the extraction query representation satisfies a matching condition with respect to either one of the third node information or the fourth node information of a first node in the second combined lexical representation, the third node information, the fourth node information, the third edge information and the fourth edge information of the first node from the second combined lexical representation as the extraction information.
(Aspect 13)
The word extraction device according to any one of aspects 7 through 12, wherein in a case that lexical attribute information is received that indicates a predetermined lexical attribute, the word extraction unit:
   compares the extraction query representation with the second combined lexical representation;
   identifies a first node in the second combined lexical representation for which the predetermined lexical attribute matches between the extraction query representation and the second combined lexical representation; and
   extracts node information and edge information of the first node from the second combined lexical representation as the extraction information.
(Aspect 14)
The word extraction device according to aspect 13, wherein the lexical attribute includes one or more selected from the group consisting of a lemma, a part-of-speech, and a consonant.
(Aspect 15)
A word extraction method comprising:
   a step of acquiring training data that includes sentences in which target extraction words are specified;
   a step of acquiring a target search document;
   a step of generating, by processing the training data with a first parsing technique, a first lexical representation having a graph structure that represents the target extraction words as nodes including first node information and relationships between the target extraction words as edges including first edge information;
   a step of generating, by processing the training data with a second parsing technique, a second lexical representation having a graph structure that represents the target extraction words as nodes including second node information and relationships between the target extraction words as edges including second edge information;
   a step of identifying a first shared node in the first lexical representation and a second shared node in the second lexical representation as shared nodes that are shared between the first lexical representation and the second lexical representation;
   a step of calculating a normalized edit distance between the first shared node and the second shared node;
   a step of generating a first combined lexical representation that includes the first node information, the first edge information, the second node information and the second edge information by mapping, in a case that the normalized edit distance that was calculated satisfies a predetermined normalized edit distance criterion, the second node information and the second edge information associated to the second shared node to the first shared node in the first lexical representation;
   a step of generating a subgraph that indicates a portion of the first combined lexical representation as an extraction query representation indicating a query for extracting the target extraction words from the target search document;
   a step of generating, by processing the target search document with the first parsing technique, a third lexical representation having a graph structure that represents words of the target search document as nodes including third node information and relationships between words as edges including third edge information;
   a step of generating, by processing the target search document with the second parsing technique, a fourth lexical representation having a graph structure that represents words of the target search document as nodes including fourth node information and relationships between words as edges including fourth edge information;
   a step of generating a second combined lexical representation that includes the third node information, the third edge information, the fourth node information and the fourth edge information by combining the third lexical representation and the fourth lexical representation; and
   a step of extracting, by using the extraction query representation, extraction information that indicates information about the target extraction words from the second combined lexical representation.

Although the embodiments of the present invention have been described above, the present invention is not limited to the above-described embodiments, and various modifications are possible without departing from the gist of the present invention.

### REFERENCE SIGNS LIST

150 . . . Word extraction application
410 . . . Word extraction device
420 . . . Memory
422 . . . Lexical representation generation unit
424 . . . Query representation generation unit
426 . . . Word extraction unit
430 . . . Storage unit
432 . . . Training data DB
434 . . . Lexical representation DB
436 . . . Target search document DB
444 . . . Processor
446 . . . Input/output unit
450 . . . Communication network
460 . . . User terminal

What is claimed is:

1. A word extraction device comprising:
a processor; and
a memory,
wherein the memory includes processing instructions for causing the processor to function as:
a lexical representation generation unit for acquiring training data that includes sentences in which target extraction words are specified, generating a first lexical representation by processing the training data with a first parsing technique, generating a second lexical representation by processing the training data with a second parsing technique, and generating a first combined lexical representation by combining the first lexical representation and the second lexical representation;
a query representation generation unit for generating, based on the first combined lexical representation, an extraction query representation that indicates a query for extracting the target extraction words from a predetermined target search document; and
a word extraction unit for extracting, by using the extraction query representation, extraction information that indicates information about the target extraction words from a second combined lexical representation generated based on the target search document.

2. The word extraction device according to claim 1, wherein:
the first parsing technique is an Abstract Meaning Representation technique; and
the second parsing technique is a Dependency Parsing technique.

3. The word extraction device according to claim 1, wherein:
the first lexical representation, the second lexical representation, the first combined lexical representation, the second combined lexical representation, and the extraction query representation have a graph structure in which words are represented as nodes, and relationships between words are represented as edges.

4. The word extraction device according to claim 3, wherein:
each node in the first lexical representation is associated with first node information and first edge information from the first parsing technique;
each node in the second lexical representation is associated with second node information and second edge information from the second parsing technique; and
the lexical representation generation unit:
compares a first node in the first lexical representation with a second node in the second lexical representation, and identifies nodes shared between the first lexical representation and the second lexical representation as shared nodes; and
generates the first combined lexical representation by mapping the first node information and the first edge information associated with a first shared node among the shared nodes to a second shared node among the shared nodes in the second lexical representation.

5. The word extraction device according to claim 4, wherein, in generation of the first combined lexical representation, the lexical representation generation unit:
calculates a normalized edit distance between nodes in the first lexical representation and nodes in the second lexical representation; and
identifies nodes that satisfy a predetermined normalized edit distance criterion as the shared nodes.

6. The word extraction device according to claim 4, wherein:
the query representation generation unit generates a subgraph representing a portion of the first combined lexical representation as the extraction query representation.

7. The word extraction device according to claim 6, wherein the lexical representation generation unit:
generates a third lexical representation by processing the target search document using the first parsing technique, generates a fourth lexical representation by processing the target search document using the second parsing technique, and generates the second combined lexical representation by combining the third lexical representation and the fourth lexical representation; and
each node in the second combined lexical representation is associated with third node information and third edge information from the first parsing technique and fourth node information and fourth edge information from the second parsing technique.

8. The word extraction device according to claim 7, wherein the word extraction unit:
compares the extraction query representation with the second combined lexical representation; and
extracts, in a case that it is determined that either one of the first node information or the second node information of each node in the extraction query representation satisfies a matching condition with respect to either one of the third node information or the fourth node information of a first node in the second combined lexical representation, and either one of the first edge information or the second edge information of each node in the extraction query representation satisfies a matching condition with respect to either one of the third edge information or the fourth edge information of the first node in the second combined lexical representation, the third node information, the fourth node information, the third edge information, and the fourth edge information of the first node from the second combined lexical representation as the extraction information.

9. The word extraction device according to claim 7, wherein the word extraction unit:
compares the extraction query representation with the second combined lexical representation; and
extracts, in a case that it is determined that both of the first node information and the second node information of each node in the extraction query representation satisfies a matching condition with respect to the third node information and the fourth node information of a first node in the second combined lexical representation, and both of the first edge information and the second edge information of each node in the extraction query representation satisfy a matching condition with respect to the third edge information and the fourth edge information of the first node in the second combined lexical representation, the third node information, the fourth node information, the third edge information, and the fourth edge information of the first node from the second combined lexical representation as the extraction information.

10. The word extraction device according to claim 7, wherein:
in a case that a performance of the first parsing technique satisfies a first performance criterion, the word extraction unit:
compares the extraction query representation with the second combined lexical representation, and
extracts, in a case that it is determined that the first node information of each node in the extraction query representation satisfies a matching condition with respect to the third node information of a first node in the second combined lexical representation and the first edge information of each node in the extraction query representation satisfies a matching condition with respect to the third edge information of the first node in the second combined lexical representation, the third node information and the third edge information of the first node from the second combined lexical representation as the extraction information; and
in a case that a performance of the second parsing technique satisfies a second performance criterion, the word extraction unit:
extracts, in a case that it is determined that the second node information of each node in the extraction query representation satisfies a matching condition with respect to the fourth node information of the first node in the second combined lexical representation and the second edge information of each node in the extraction query representation satisfies a matching condition with respect to the fourth edge information of the first node in the second combined lexical representation, the fourth node information and the fourth edge information of the first node from the second combined lexical representation as the extraction information.

11. The word extraction device according to claim 7, wherein in a case that matching necessity information is received that defines a matching necessity criterion defining nodes and edges that need to match and nodes and edges that do not need to match between the extraction query representation and the second combined lexical representation, the word extraction unit:
compares the extraction query representation with the second combined lexical representation; and
identifies a first node in the second combined lexical representation that satisfies the matching necessity criterion; and
extracts node information and edge information of the first node from the second combined lexical representation as the extraction information.

12. The word extraction device according to claim 7, wherein in a case that fifth node information is received that indicates related terms of a second node in the extraction query representation, the word extraction unit:
compares the extraction query representation with the second combined lexical representation; and
extracts, in a case that the fifth node information of the second node in the extraction query representation satisfies a matching condition with respect to either one of the third node information or the fourth node information of a first node in the second combined lexical representation, the third node information, the fourth node information, the third edge information and the fourth edge information of the first node from the second combined lexical representation as the extraction information.

13. The word extraction device according to claim 7, wherein in a case that lexical attribute information is received that indicates a predetermined lexical attribute, the word extraction unit:
compares the extraction query representation with the second combined lexical representation;
identifies a first node in the second combined lexical representation for which the predetermined lexical attribute matches between the extraction query representation and the second combined lexical representation; and
extracts node information and edge information of the first node from the second combined lexical representation as the extraction information.

14. The word extraction device according to claim 13, wherein the lexical attribute includes one or more selected from the group consisting of a lemma, a part-of-speech, and a consonant.

15. A word extraction system comprising:
a user terminal and a word extraction device connected via a communication network;
wherein:
the word extraction device includes:
a processor, and
a memory; and
the memory includes:
processing instructions for causing the processor to function as:
a lexical representation generation unit for acquiring, from the user terminal, training data that includes sentences in which target extraction words are specified, generating a first lexical representation by processing the training data with a first parsing technique, generating a second lexical representation by processing the training data with a second parsing technique, and generating a first combined lexical representation by combining the first lexical representation and the second lexical representation,
a query representation generation unit for generating, based on the first combined lexical representation, an extraction query representation that indicates a query for extracting the target extraction words from a predetermined target search document, and
a word extraction unit for extracting, by using the extraction query representation, extraction information that indicates information about the target extraction words from a second combined lexical representation generated based on the target search document, and outputting the extraction information to the user terminal.

16. A word extraction method comprising:
a step of acquiring training data that includes sentences in which target extraction words are specified;
a step of generating a first lexical representation by processing the training data with a first parsing technique;
a step of generating a second lexical representation by processing the training data with a second parsing technique;
a step of generating a first combined lexical representation by combining the first lexical representation and the second lexical representation;
a step of generating, based on the first combined lexical representation, an extraction query representation that indicates a query for extracting the target extraction words from a predetermined target search document; and
a step of extracting, by using the extraction query representation, extraction information that indicates information about the target extraction words from a second combined lexical representation generated based on the target search document.
